(19) United States
(12) Patent Application Publication
(10) Pub. No.: US 2025/0074281 A1
(43) Pub. Date: Mar. 6, 2025

(54) TABLE-AND-GLOVE BOX FOR VEHICLES

(71) Applicant: DAEHAN SOLUTION CO., LTD., Incheon, (KR)

(72) Inventors: CHOONG HO KWON, SEOUL (KR); DAEHEE PARK, INCHEON (KR)

(21) Appl. No.: 18/802,589

(22) Filed: Aug. 13, 2024

(30) Foreign Application Priority Data
Aug. 31, 2023 (KR) 10-2023-0115070

(51) Int. Cl. B60N 3/00; B60R 7/06

(52) U.S. Cl. CPC B60N 3/002; B60R 7/06

(57) ABSTRACT

By configuring a table to be stored in a glove box and configuring the table to be used by opening the glove box and then pulling out the table, a passenger in a passenger seat may also use the table, and when not in use, the table may be stored in the glove box so as not to spoil the appearance and aesthetics of the vehicle interior. In particular, by configuring the table so that a fixed state thereof is immediately released when the table is pressed and an unfolded state is maintained when the table pulled out from the glove box is unfolded and then is pushed toward the front in a traveling direction of a vehicle, the table may be conveniently used by being immediately unfolded when needed through a configuration of being easily pressed by hand while having a simple structure. In addition, by configuring the table to be used with the glove box less open, a table of sufficient width may be secured so that the passenger in the passenger seat may conveniently use the table.

### CROSS-REFERENCE TO RELATED APPLICATION

This application claims priority to and the benefit of Korean Patent Application No. 10-2023-0115070, filed on Aug. 31, 2023, the disclosure of which is incorporated herein by reference in its entirety.

### BACKGROUND

### 1. Field of the Invention

The present invention relates to a table-and-glove box for vehicles, and more specifically, to a table-and-glove box for vehicles capable of configuring a table at the front of a glove box to be stored and pulled out to allow a passenger sitting in a passenger seat to open the glove box and unfold the table to do work, use the table as a cup holder, or have a light meal. In addition, the table may be easily and conveniently used simply with a pressing operation using a one-touch stopper to easily release the table when the one-touch stopper is pressed once and put the released table into a caught state when the one-touch stopper is pressed again. In addition, the table may be configured to be unfolded and used in a state where the glove box is slightly open so that the table is spread out as widely as possible to be conveniently used.

### 2. Discussion of Related Art

In general, vehicles are equipped with tables for passengers to use. The table is usually folded or stored out of sight when not in use, and unfolded and used when needed.

In Korean Patent Registration No. 10-2565475 (Registration date: Aug. 9, 2023), Korean Patent Registration No. 10-2554297 (Registration Date: Jul. 6, 2023), and Korean Patent Publication No. 10-2022-0132358 (Publication Date: Sep. 30, 2022) below, technology related to the table used in the vehicle is disclosed.

Korean Patent Registration No. 10-2565475 discloses a table for vehicles. The table for vehicles includes a table body, a seat connecting portion that is provided at a lower portion of the table body and has an isofix connector that is detachably coupled to an isofix anchor of a vehicle seat, and a support leg that is provided at the lower portion of the table body to be hingedly rotatable so that the support leg is foldable toward the table body and has an end of which is in contact with an interior floor of the vehicle to support the table body. According to the configuration, as a structure of being detachably coupled to the isofix anchor of the vehicle seat is provided, the table for vehicles is convenient to install and use, and may be applied to all types of vehicles regardless of vehicle model.

Korean Patent Registration No. 10-2554297 discloses a vehicle with a folding table including an interior space, in which the vehicle includes a floor surface positioned on one side in a height direction of the vehicle and a first wall positioned on one side in a width direction of the vehicle, and the vehicle includes a 1-1 guide line disposed in a first region of the floor surface and extending long in a first direction, a second guide line disposed in a second region of the first wall and extending long in the same direction as the 1-1 guide line, a console box disposed on the floor surface and moving along the 1-1 guide line, and a first table unit disposed on the first wall and moving along the second guide line, so that a first folding table of the first table unit may move along the 1-1 guide line, that is, may move inside the vehicle, thereby increasing the usability of the first folding table.

In Korean Patent Publication No. 10-2022-0132358, by configuring two expansion covers on an inner cover finishing a console, when the inner cover may be fully tilted back from the console, and then the expansion covers may be unfolded again, the covers are used as a multi-purpose table that is about twice the size of the inner cover. In particular, by configuring the covers so that when the inner cover is unfolded by being tilted back, the expansion covers are unfolded from the bottom of the inner cover upward to form a single plane with the inner cover, the expansion cover may be supported by the leg, thereby preventing the expansion covers from easily folding or rotating so that the covers are safely and conveniently used. In addition, by configuring the leg to be inserted into the expansion cover as an embedded type and rotated outward to support the expansion cover only when in use, the multi-purpose table secures as large a size as possible and takes up a minimal space when not in use.

### SUMMARY OF THE INVENTION

However, the existing tables have the following inconveniences.
(1) It is cumbersome to use the tables because the tables have to be stored on the side or bottom of a seat for vehicles and taken out and used when needed.
(2) In addition, most existing tables for vehicles are often configured so that rear seat passengers are able to board and use the tables. Therefore, there is the inconvenience of a passenger sitting in a passenger seat not being able to use the tables.
(3) Accordingly, since when the passenger sitting in the passenger seat tries to work or eat a light meal, the table may not be used, there is a concern that the passenger may not work or spill food due to shaking while eating.
(4) Meanwhile, the existing tables are sometimes installed so that the tables are visible to a driver and passengers when the passengers are on board. The tables mounted in this way provide convenience when used, but not only do the tables reduce the utilization of a limited space of a vehicle, but the tables also harm the appearance and aesthetics of the vehicle interior.
(5) In particular, passengers who do not frequently use the tables may feel uncomfortable just by seeing the tables.

The present invention has been conceived in consideration of the aforementioned problems, and is directed to providing a table-and-glove box for vehicles capable of configuring the table to be stored at the front of a glove box and configuring the table to be used by opening the glove box and then pulling out the table when the table is used, thereby allowing even a passenger in a passenger seat to conveniently use a table and also allowing the table to be conveniently used without spoiling the appearance and aesthetics of the vehicle interior and also without reducing the space utilization of the vehicle interior by being stored in the glove box when the table is not used.

In particular, the present invention is also directed to providing a table-and-glove box for vehicles capable of configuring a table so that a fixed state is immediately released when the table stored in a glove box is pressed and an unfolded state is maintained when the table pulled out from the glove box is unfolded and is pushed toward the front in a traveling direction of a vehicle, thereby allowing the table to be conveniently used by being immediately unfolded when needed through a configuration of being easily pressed by hand while having a simple structure.

In addition, the present invention is also directed to providing a table-and-glove box for vehicles capable of configuring a table to be pulled out and used with a glove box less open, thereby securing a wide space between a passenger in a passenger seat and an open glove box to secure a table of sufficient width so that the passenger in the passenger seat conveniently uses the table.

In order to solve the aforementioned problems, according to an aspect of the present invention, there is provided a table-and-glove box for vehicles, including a box body (100) mounted on a dashboard of a vehicle, in which the box body (100) includes a guide (110) formed on an inside of a front surface, a table (120) configured to slide within the guide (110) and used by being pulled out from the guide 110 when the box body (100) is opened, a first one-touch stopper (130′) mounted inside the guide (110) so that when the table (120) is pressed into the guide (110) and a hand is taken away therefrom, at least one protrusion (121) formed on an inner edge of the table (120) is caught or released, and a second one-touch stopper (130″) mounted at an entrance of the guide (110) so that when the table (120) is pushed in a traveling direction of the vehicle in a state where the box body (100) is opened and the table (120) is unfolded, the protrusion (121) is caught or released.

In particular, the guide (110) may be formed to be unfolded flat when the box body (100) is opened.

In addition, the box body (100) may be configured to be used as a glove box so that the table (120) is unfolded and used when the box body is opened at a smaller angle than when the box body is fully opened.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view showing a portion of a vehicle interior showing a position where a table-and-glove box for vehicles according to the present invention is mounted;

A set of FIGS. 2A and 2B are views showing the table-and-glove box for vehicles according to the present invention, where FIG. 2A is a perspective view and FIG. 2B is a cross-sectional view;

FIG. 3 is a cross-sectional view showing a state where a table is released by pressing the table for using the table-and-glove box for vehicles according to the present invention as a table;

FIG. 4 is a cross-sectional view showing a process of withdrawing the table according to the present invention from a guide to use the table;

FIG. 5 is a cross-sectional view showing a state where the table withdrawn from the guide is pushed and fixed in a traveling direction of a vehicle according to the present invention; and

FIG. 6 is a cross-sectional view showing a state where the table according to the present invention is fixed to a glove box.

### DETAILED DESCRIPTION OF EXEMPLARY EMBODIMENTS

Hereinafter, preferred embodiments of the present invention will be described in more detail with reference to the accompanying drawings. Prior to the description, terms or words used in this specification and claims should not be restrictively interpreted as ordinary meanings or dictionary-based meanings, but should be interpreted as meanings and concepts conforming to the technical aspects of the present invention according to the principle that an inventor is allowed to properly define concepts of terms to describe his or her invention in the best ways.

Therefore, embodiments described in the specification and configurations shown in the drawings are merely the most preferred embodiment of the present invention, but are not intended to fully describe the technical aspects of the present invention, so it should be understood that a variety of other equivalents and modifications could be made thereto at the time of filing the application.

### Configuration of Table-and-Glove Box for Vehicles

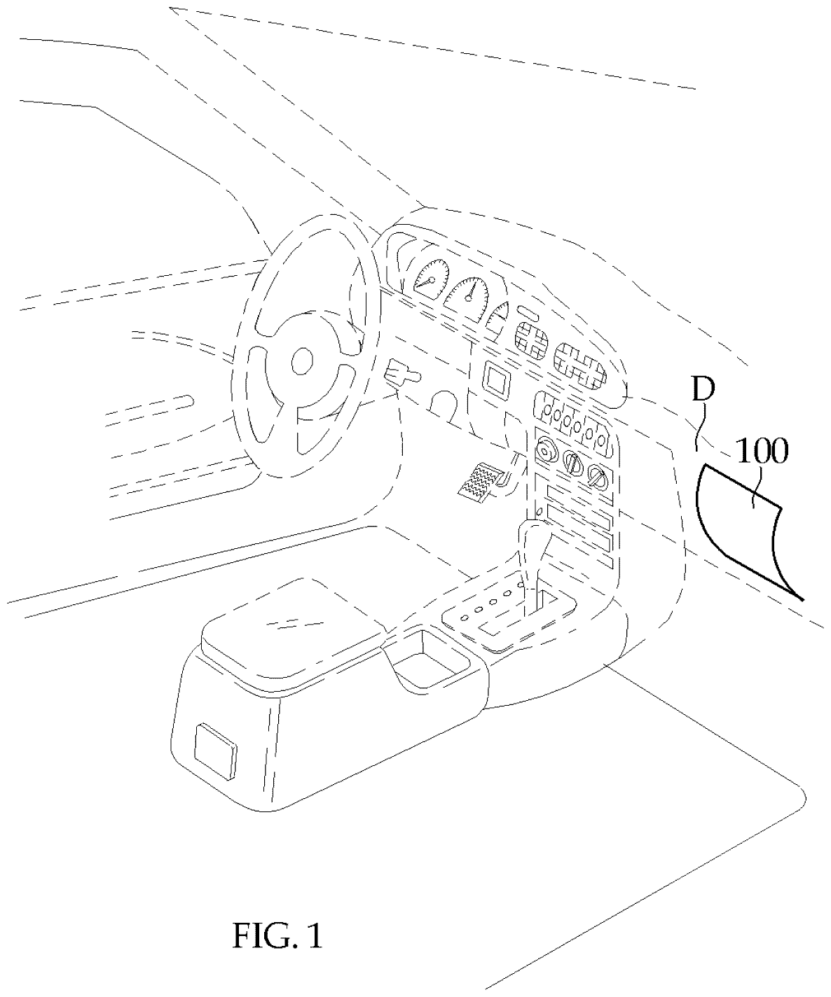

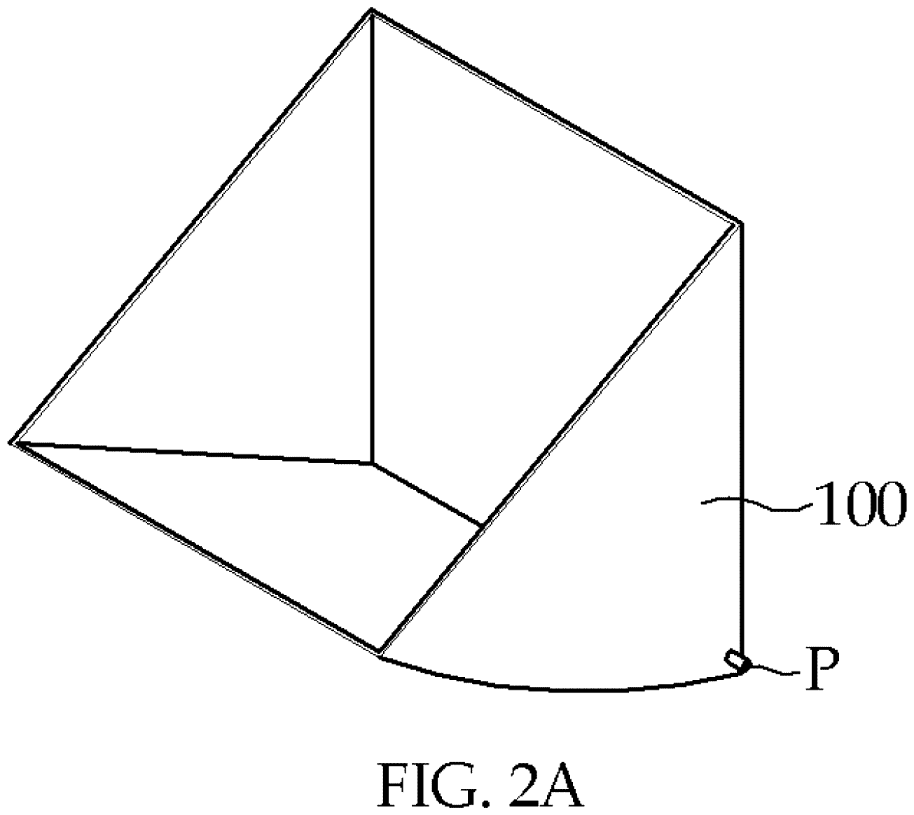

As shown in FIGS. 1 to 6, a table-and-glove box for vehicles according to the present invention includes a box body 100 mounted on a dashboard D of a vehicle.

In particular, in the box body 100, a table 120 is configured to be stored and pulled out along a guide 110 formed at the front, so that the table 120 may be pulled out and unfolded with the box body 100 open, and then a passenger in a passenger seat may conveniently use the table.

In this case, by configuring the table 120 to be used by being horizontally unfolded with the box body 100 open, the table 120 may be stably used even when a vehicle is traveling.

In addition, by configuring the box body 100 so that the table 120 is able to be pulled out and used in a state where the box body 100 is opened less than when an item therein is inserted or taken out, an interval between the box body 100 and the passenger in the passenger seat may be widened as much as possible to secure a sufficient width of the table 120.

Meanwhile, by employing a one-touch stopper method that unlocks by pressing a button once and locks by pressing the button again as a bottom method as a means of preventing the table 120 from being separated from the guide 110 or maintaining an unfolded state, anyone may easily use the table 120.

Hereinafter, such a configuration will be described in more detail with reference to the accompanying drawings. Here, the reference numeral “D” represents a dashboard installed to be wider in a width direction of the vehicle in front of a driver's seat and a passenger seat inside the vehicle, and “P” represents a pin that becomes the center of rotation when the box body rotates.

### A. Box Body

As shown in FIGS. 1 to 2B, the box body 100 is mounted at a position facing the passenger seat on a dashboard D configured inside the vehicle. In this case, the box body 100 is configured to open and close while rotating up and down toward the passenger seat.

That is, as shown in FIGS. 1 to 2B, the box body 100 is made in the shape of a container, and the front is mounted to rotate around a pin P so that the front forms a surface of the dashboard D when the box body 100 is closed. In addition, at the front, a lock assembly manufactured using conventional technology so that a driver or passenger is able to unlock the box body 100 by hand is provided.

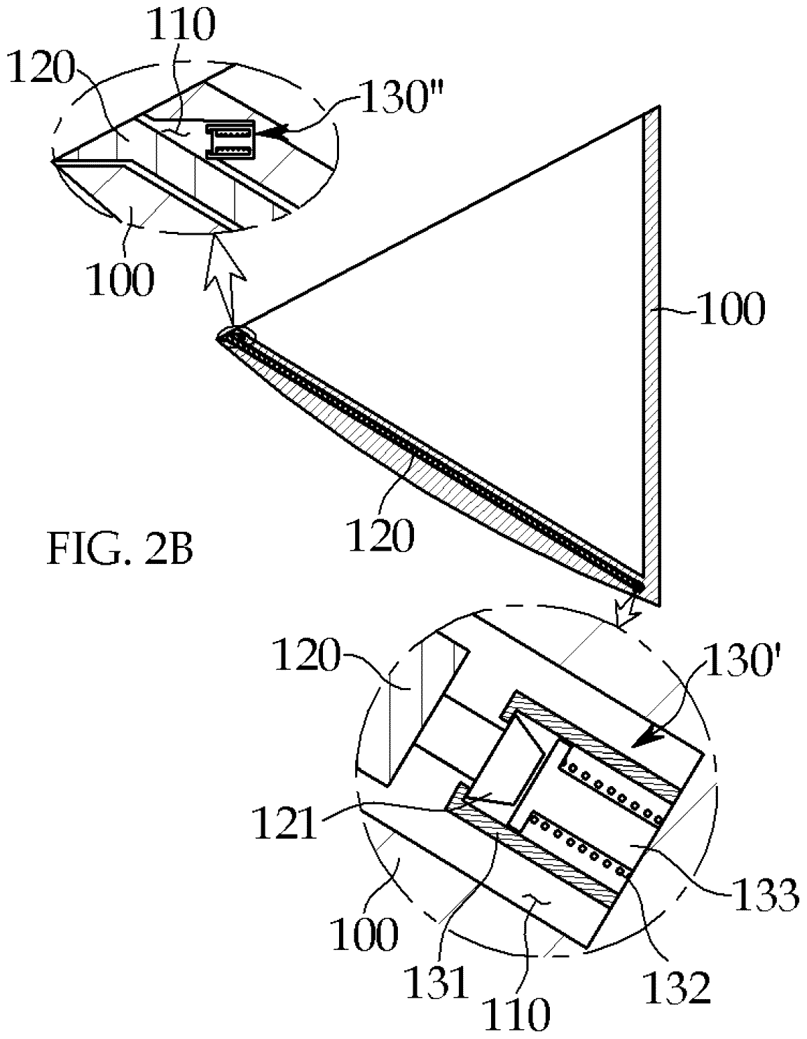

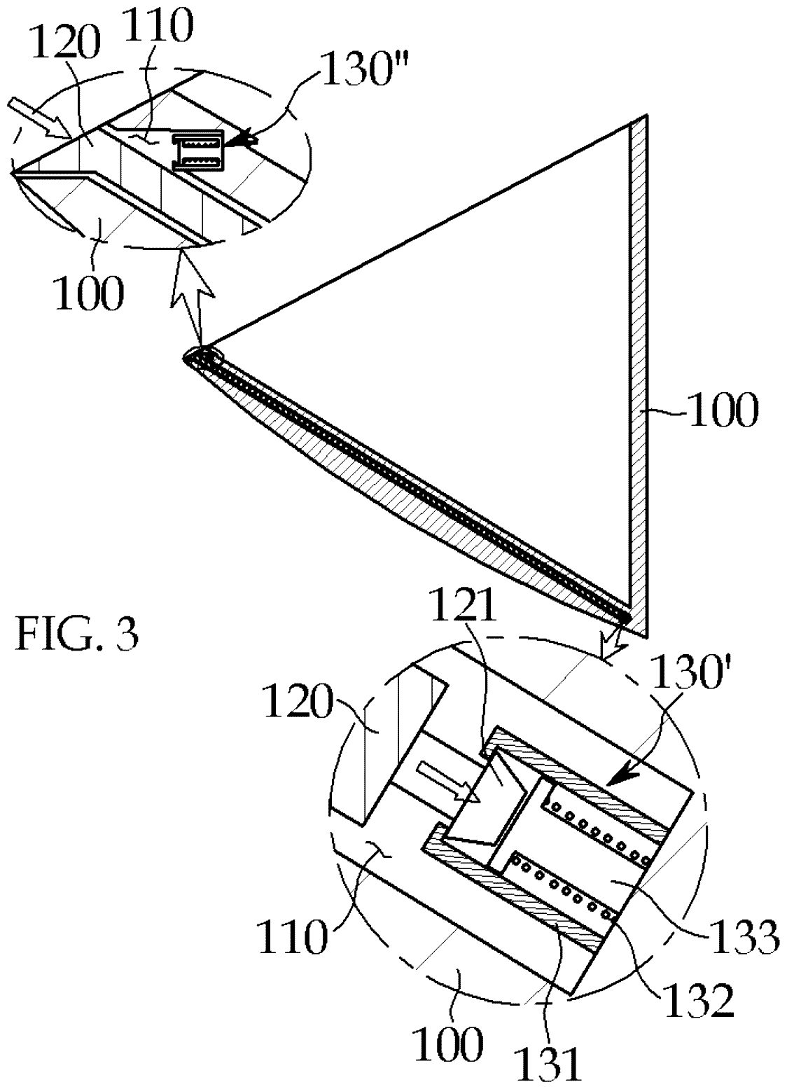

In addition, in a preferred embodiment of the present invention, as shown in FIGS. 2A to 3, the box body 100 may be configured so that the table 120, which will be described below, may be unfolded and used in a fully open state, but it may be preferable to configure the box body 100 to restrict the rotation thereof so that the table 120 may be unfolded and used when the box body 100 is not fully opened. This is because as the box body 100 is not fully opened, not only may an unfolding height of the table 120, which will be described below, be increased as much, but also an interval between the box body 100 and the passenger seat may be widened to make the table 120 as widely as possible. As a means of preventing the box body 100 from being fully opened in this way, a hook may be added to a side surface of the box body 100 and hung on the dashboard to limit a rotation angle, a step motor may be mounted on the pin P to limit the rotation angle, or an uneven structure may be added between the box body 100 and the dashboard facing each other to forcibly move across to adjust the rotation angle.

As shown in FIGS. 2A to 6, the box body 100 includes the guide 110, the table 120, a first one-touch stopper 130′, and a second one-touch stopper 130″.

### B. Guide

As shown in FIGS. 2A to 3, the guide 110 is formed in a thickness portion of the surface of the box body 100 that becomes one surface with the dashboard D when the glove box is closed. In this case, the guide 110 is for guiding the table 120, which will be described below, to be stored and then pulled out onto the box body 100, and has the first one-touch stopper 130′, which will be described below, mounted therein to support the table 120 so that the table 120 is not separated from the guide 110 and has the second one-touch stopper 130″ mounted at an entrance thereof to maintain the table 120 in the unfolded state when the table is unfolded.

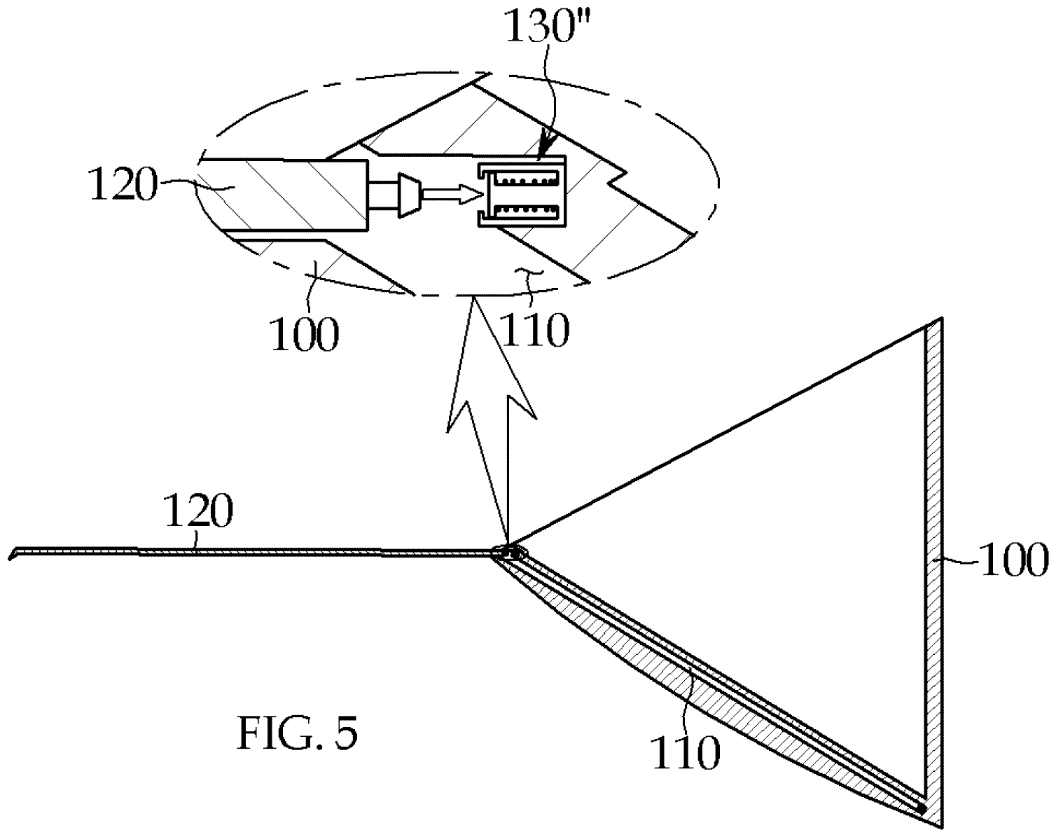

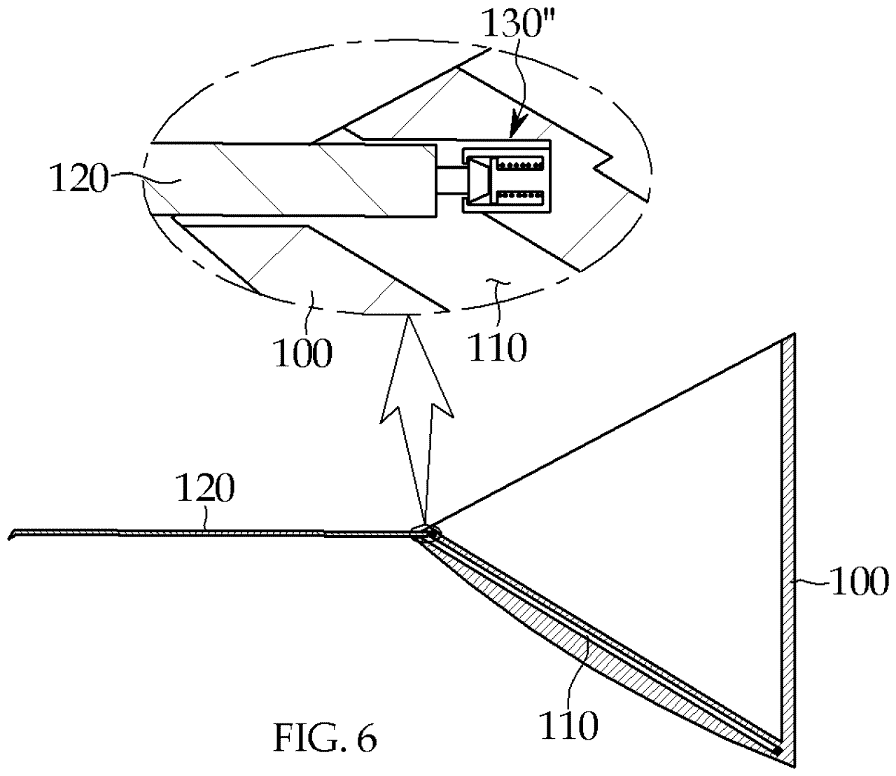

Meanwhile, as shown in FIGS. 5 and 6, it may be preferable that the guide 110 is configured to, when the table 120, which will be described below, is pulled out, maintain a horizontal state by supporting an edge of the table 120 over the entrance of the guide 110.

### C. Table

As shown in FIGS. 2A to 5, the table 120 is formed to a size capable of being stored in the guide 110 described above and is manufactured so that an upper edge thereof is exposed to the vehicle interior so that the table may be pressed from the passenger seat. In this case, the table 120 has at least one protrusion 121 protruding from the inner edge of the table 120 and is caught by a first one-touch stopper 130′, which will be described below, mounted inside the guide 110, so that the table 120 is maintained in an accommodated state. The number of protrusions 121 is sufficient to support the table 120 so as not to be separated or coming out from the guide 110 due to vibration received when the vehicle is traveling, for example, two protrusions 121 may be formed at the inner edge of the table 120, on each side.

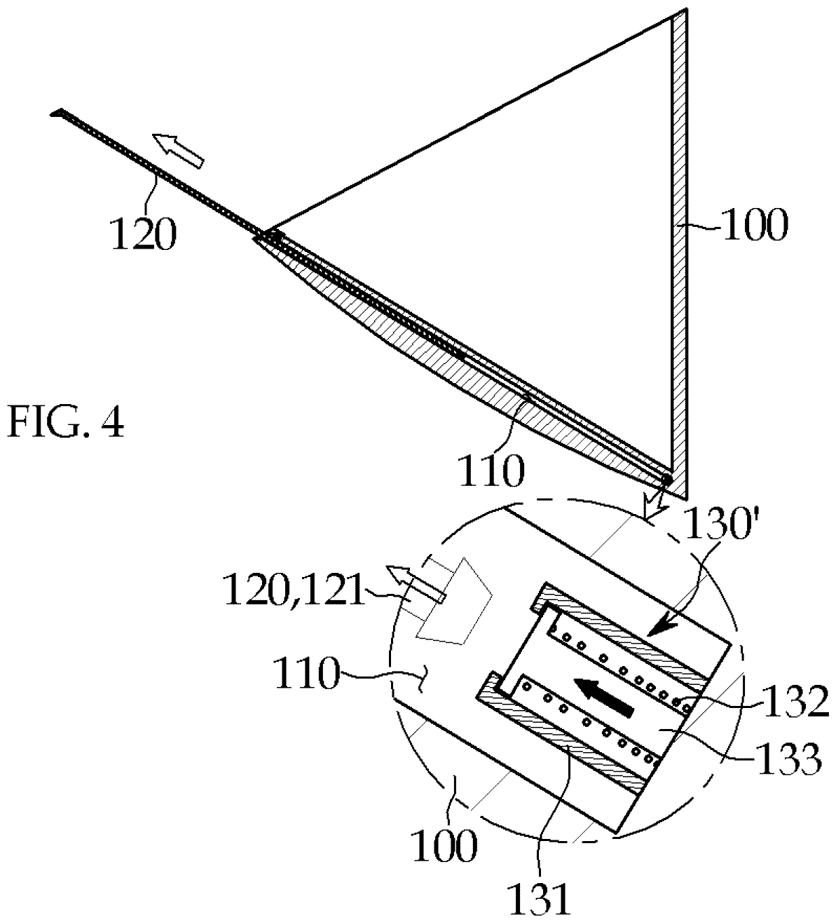

Meanwhile, as shown in FIGS. 4 and 5, by configuring the table 120 to be fully separated from the guide 110 when the catching is released from the first one-touch stopper 130′, which will be described below, the table 120 may be used as a support, or the table 120 may be configured to be stored and pulled out under the guidance of the guide 110 without being fully separated from the guide 110. In order to enable storage and pull-out in this way, for example, a separate sub-guide may be formed within the guide 110, and a jaw may be formed on the table 120 so that the table 120 is guided along the sub-guide without being separated or coming out.

In addition, as shown in FIGS. 4 to 6, when the table 120 exits from the guide 110 described above, it may be preferable that the table 120 is unfolded flat while the protrusion 121 is caught by the second one-touch stopper 130″, which will be described below, when the table 120 is pushed in a traveling direction of the vehicle in a state of being unfolded so that the inner edge thereof is supported over the entrance of the guide 110. This is for preventing food, items, writing utensils, and the like, placed on the table when the table 120 is used from falling while the vehicle is traveling.

Of course, although not shown in the drawing, it may be preferable that in the table 120, when unfolded flat in this way, a hump is formed on the edge of the upper surface to prevent items rolling on the table from falling or a groove is formed so that a cup or the like placed on the table is supported so as not to easily fall over.

### D. First and Second One-Touch Stoppers

As shown in FIGS. 3 to 6, the first and second one-touch stoppers 130′ and 130″ have the same configuration, but are different in that the first one-touch stopper 130′ has a function of fixing the protrusion 121 when the table 120 is stored in the guide 110 and the second one-touch stopper 130″ fixes the protrusion 121 when the table 120 is pulled out from the guide 110 and unfolded flat. Accordingly, the description here will focus on the configuration of the first one-touch stopper 130′.

As shown in FIGS. 2A to 4, the first one-touch stopper 130′ includes an elastic jaw 131 formed so that the protrusion 121 described above is forcibly inserted or separated and a pusher 133 supported by a spring 132 inside the elastic jaw 131. As the first one-touch stopper 130′ presses the table 120 at the entrance of the guide 110, the protrusion 121 presses the elastic jaw 131 so that the spring 132 is pressed. When the force applied to the table 120 is removed in this state, the protrusion 121 is separated outward while elastically deforming the elastic jaw 131 by being forcibly bounced by the force of the spring 132, and thus the catching is released.

Conversely, the first one-touch stopper 130′ allows the table 120 to be accommodated within the guide 110 so that when the outer edge is pressed, the protrusion 121 is forcibly caught while forcibly opening the elastic jaw 131, and accordingly, the pusher 133 supports the protrusion 121 while receiving elastic support from the spring 132.

Meanwhile, as described above, the second one-touch stopper 130″ has the same configuration as the first one-touch stopper 130′, but as described in FIGS. 4 to 6, when the table 120 is pushed in the traveling direction of the vehicle in a state where the catching of first one-touch stopper 130′ as described above is released and the table 120 is supported flat by the entrance of the guide 110, the protrusion 121 is caught by the elastic jaw and presses the pusher 133 to receive elastic support from the spring 132. When the outer edge of the table 120 is pressed once again, the second one-touch stopper 130″ is forcibly separated from the elastic jaw due to the elastic force of the spring 132 supporting the pusher 133 and the catching is released.

As described above, in the present invention, by configuring the table in the glove box to be unfolded and used with the glove box open, the table may not be exposed to the outside when not used, thereby allowing the passenger in the passenger seat to conveniently use the table while improving the appearance and aesthetics of the vehicle interior. The table-and-glove box for vehicles according to the present invention has the following effects.
(1) A table can be configured at the front of a glove box, and a glove box can be opened when needed, and then the table can be pulled out and then unfolded to be immediately used, so that a passenger in a passenger seat can also use the table.
(2) In particular, as the table is configured to be stored in the glove box and pulled off therefrom, the glove box can be opened and then the table can be unfolded and used anytime the table is needed without spoiling the appearance and aesthetics of the vehicle interior, as well as without reducing the space utilization of the limited vehicle interior.
(3) In this case, since the table is configured to be used by unfolding the table with the glove box not fully opened, as an interval between the passenger in the passenger seat and the opened glove box is secured as widely as possible, the area of the table can also be secured as widely as possible.
(4) Accordingly, the table can be used for various purposes such as placing and viewing documents necessary for work, using the table as a table for a light meal, or placing beverage cups or the like as a cup holder.
(5) Meanwhile, since the table is configured to be caught or released by simply pressing the table using a one-touch stopper, anyone can easily and conveniently unfold and use the table.

What is claimed is:

1. A table-and-glove box for vehicles, comprising a box body (100) mounted on a dashboard of a vehicle,
wherein the box body (100) includes:
a guide (110) formed on an inside of a front surface;
a table (120) configured to slide within the guide (110) and used by being pulled out from the guide 110 when the box body (100) is opened;
a first one-touch stopper (130′) mounted inside the guide (110) so that when the table (120) is pressed into the guide (110) and a hand is taken away therefrom, at least one protrusion (121) formed on an inner edge of the table (120) is caught or released; and
a second one-touch stopper (130″) mounted at an entrance of the guide (110) so that when the table (120) is pushed in a traveling direction of the vehicle in a state where the box body (100) is opened and the table (120) is unfolded, the protrusion (121) is caught or released.

2. The table-and-glove box for vehicles of claim 1, wherein the guide (110) is formed to be unfolded flat when the box body (100) is opened.

3. The table-and-glove box for vehicles of claim 2, wherein the box body (100) is configured to be used as a glove box so that the table (120) is unfolded and used when the box body is opened at a smaller angle than when the box body is fully opened.

4. The table-and-glove box for vehicles of claim 1, wherein the box body (100) is configured to be used as a glove box so that the table (120) is unfolded and used when the box body is opened at a smaller angle than when the box body is fully opened.
